(19) United States
(12) Patent Application Publication
(10) Pub. No.: US 2019/0005836 A1
(43) Pub. Date: Jan. 3, 2019

(54) Notification System For Educational Reinforcement

(71) Applicant: Aquinas Training, LLC, Stamford, CT (US)

(72) Inventor: Hugh Seaton, Stamford, CT (US)

(73) Assignee: Aquinas Training, LLC, Stamford, CT (US)

(21) Appl. No.: 16/021,909

(22) Filed: Jun. 28, 2018

Related U.S. Application Data
(60) Provisional application No. 62/526,076, filed on Jun. 28, 2017.

(51) Int. Cl. G09B 7/04; G09B 5/02; H04L 29/08; G06F 11/34; H04W 4/02

(52) U.S. Cl. CPC G09B 7/04; G09B 5/02; H04W 4/02; G06F 11/3438; H04L 67/26

(57) ABSTRACT

A training reinforcement notification system including an authoring platform computer, a notification computer, a notification database, and a trainee device having a display. The authoring platform computer generates a training program including reinforcement content. The notification computer receives the reinforcement content and stores it in the notification database. The trainee device generates customization data which is received by the notification computer, where a content delivery program running on the notification computer processes the customization data and generates delivery preferences which are stored in the database. The content delivery program retrieves the reinforcement content and delivery preferences from the database, and generates a plurality of notifications having reinforcement content. Each of the plurality of notifications generated by the content delivery program is delivered to the trainee device based on delivery preferences.

### CROSS-REFERENCE TO RELATED APPLICATIONS

This patent application claims the benefit, under 35 U.S.C. § 119(e), of U.S. Provisional Patent Application Ser. No. 62/526,076, filed on Jun. 28, 2017, the content of which is incorporated herein by reference in its entirety.

### TECHNICAL FIELD

The present disclosure relates generally to a notification system for training reinforcement, and more particularly to a notification system having an adaptive notification schedule with content-rich notifications.

### BACKGROUND

In the field of educational training, professionals are constantly working to maintain engagement between the trainee and the course material after the initial training is complete. In order for the material to really sink in and make a difference, this ongoing engagement through follow-up work or training reinforcement is as important if not more important than the initial training session. This continued engagement with the course work may be accomplished in the form of reading articles, watching videos, taking quizzes, or any other task typically thought of as “homework.” The training reinforcement is crucial to keep the core lessons of the training session at the forefront of the trainee's mind and preventing the trainee from forgetting what they learned. Further, the timing of the training reinforcement is crucial in order to help the trainee change their behavior, e.g. if a company trains a worker to use a new feature in Microsoft Excel, then reinforcement work done right before the trainee's Tuesday morning project in Excel is far more likely to be helpful than follow-up work done on Sunday night before bed. However, timing the delivery of the training reinforcement can be quite difficult, and poses an ongoing problem faced by this industry.

First, individuals are pre-occupied with a variety of tasks at different times during the day, and in general the optimal time to receive the training reinforcement is different depending on the individual. Second, an individual might not even know or be able to identify when the best time is for them to receive a notification regarding training reinforcement. Third, the optimal time to receive a notification regarding training reinforcement may change at any given time, and likely varies depending on the content of the notification. Fourth, the content of a notification regarding training reinforcement must be appropriate for the trainee or it will likely be ignored or otherwise useless.

Finally, even if the issue of timing the delivery of notifications regarding training reinforcement is solved to the extent that the trainee receives the training reinforcement when it would be most beneficial to them and when they are able to engage with it, the trainee must actually engage for the training reinforcement to be effective. In general, removing barriers between the trainee and the content will increase the likelihood that the trainee engages with the content. In addition, the trainee is more likely to engage with the content if it is relevant and helpful. Prior art systems such as US 2014/0308646 (“Wurth”) require the user to click on a link to receive the training reinforcement, or otherwise gives the user the option of opting out or simply not opting in to receiving the training reinforcement. In other words, the notifications themselves do not include the reinforcement content.

Aspects of the present invention are directed to these and other problems.

### SUMMARY

According to an aspect of the present invention, a training reinforcement notification system is provided including an authoring platform computer, a notification computer, a notification database, and a trainee mobile device having a display. The authoring platform computer is for generating a training program including reinforcement content. The notification computer receives the reinforcement content and stores it in a notification database. The trainee mobile device generates customization data which is received by the notification computer, where a content delivery program running on the notification computer processes the customization data and generates delivery preferences which are stored in the database. The content delivery program retrieves the reinforcement content and delivery preferences from the database and generates a plurality of notifications each including reinforcement content. Each of the plurality of notifications generated by the content delivery program is delivered to the trainee mobile device based on the delivery preferences which are unique to the trainee mobile device. A display situated on the trainee mobile device shows each of the plurality of notifications including the reinforcement content after the notification is received by the trainee mobile device.

In addition to, or as an alternative to, one or more of the features described above, further aspects of the present invention can include one or more of the following features, individually or in combination: a notification schedule having a plurality of time slots is generated by the content delivery program based on the reinforcement content and the customization data. The delivery preferences of a particular notification includes a delivery time for when the particular notification is going to be delivered, and the delivery time is assigned to one of the plurality of time slots based on the customization data. Feedback information is generated by the trainee mobile device and transmitted to the notification computer. Feedback information is transmitted to the authoring platform computer. Feedback information indicates that the trainee received the notification. Feedback information indicates that the trainee interacted with the notification. Feedback information includes the device location and whether the device is being used. The plurality of notifications includes a first notification and a second notification, with the second notification being generated after the first notification, and the delivery preferences for the second notification are modified by the content delivery program based on the feedback information received by the notification computer after the trainee mobile device received the first notification. The first notification has a plurality of first notification delivery preferences including a first notification delivery time, the second notification has a plurality of second notification delivery preferences including a second notification delivery time, the second notification delivery time is set to the same time value as the first notification delivery time. Feedback information indicates the first notification was not received, and the content delivery program modifies the second notification delivery time to be different than the first notification delivery time. The feedback information indicates the first notification was not interacted with, and the content delivery program modifies the second notification delivery time to be different than the first notification delivery time. The feedback information indicates the first notification was not received, and the content delivery program modifies the reinforcement content of the second notification to be the same as the reinforcement content of the first notification. The plurality of notifications comprises a first notification, a second notification, and a third notification, such that the second notification is generated and sent to the trainee mobile device after the first notification, and the third notification is generated and sent to the trainee mobile device after the second notification, and the reinforcement content of the third notification is modified by the content delivery program based on feedback information received by the notification computer after the trainee mobile device received the first notification and feedback information received by the notification computer after the trainee mobile device received the second notification. The reinforcement content of the first notification is of a first type and the reinforcement content of the second notification is of a second type, the feedback information received by the notification computer after the trainee mobile device received the first notification indicates that the first notification was not interacted with, the feedback information received by the notification computer after the trainee mobile device received the second notification indicates that the second notification was interacted with, and the content delivery program generates the third notification to include reinforcement content of a second type. The delivery preferences are indicative of when the trainee is most likely to receive the notification and when the trainee is most likely to interact with the notification.

These and other aspects of the present invention will become apparent in light of the drawings and detailed description provided below.

### BRIEF DESCRIPTION OF THE DRAWINGS

FIG. 1 is a block diagram showing a notification system for educational reinforcement according to the present disclosure.

FIG. 2 is a flowchart illustrating a process of operating the notification system for educational reinforcement of FIG. 1.

### DETAILED DESCRIPTION

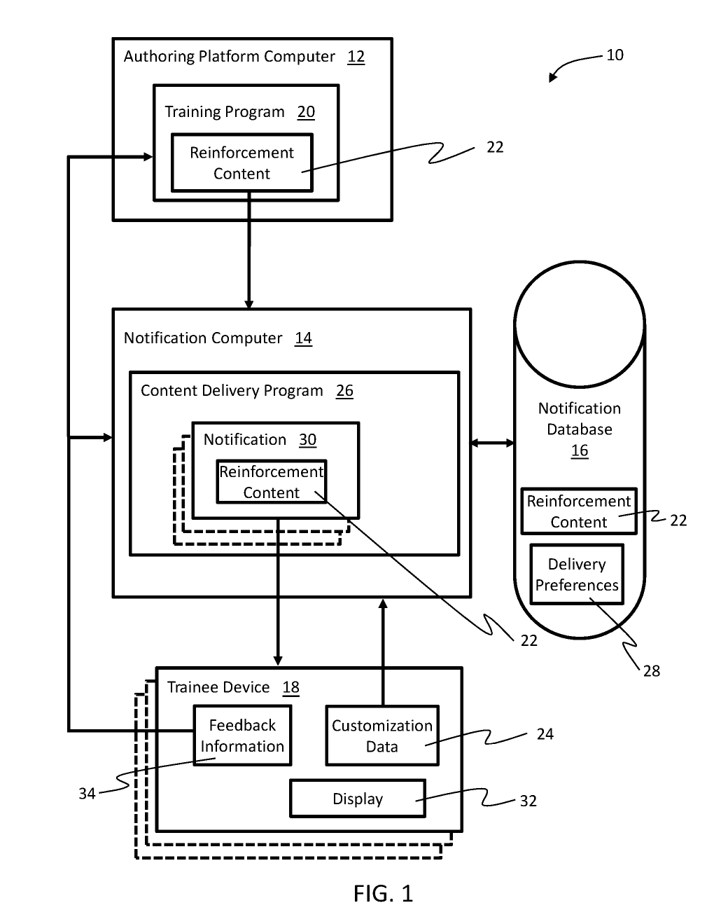

Referring to FIG. 1, the present disclosure describes a training reinforcement notification system 10. The training reinforcement notification system 10 includes an authoring platform computer 12, a notification computer 14, a notification database 16, and a trainee mobile device 18. The authoring platform computer 12 is used to generate or create a training program 20, which includes reinforcement content 22. The reinforcement content 22 is intended to be delivered to a trainee, and is designed to help them learn and use the skills and information included in the training program 20. The notification computer 14 receives the reinforcement content 22 and stores it in the notification database 16. The trainee mobile device 18 generates customization data 24, which is received by the notification computer 14, where a content delivery program 26 running on the notification computer 14 processes the customization data 24 and generates delivery preferences 28 that are then sent to the notification database 16 to be stored. The trainee device need not be mobile or wireless in nature, but can be a device commonly regarded as not mobile such as, but not limited to, a desktop computer or smart television. Further, the trainee device 18 can be, but is not limited to, a smartphone, laptop computer, PDA, cell phone, tablet, netbook, mobile phone, home entertainment device, smart watch, home automation system, personal electronic assistant such as an Amazon Echo device, automobile driver interface, or any other electronic device capable of alerting a trainee of a notification 30.

The content delivery program 26 retrieves the reinforcement content 22 and delivery preferences 28 from the notification database 16 and generates a plurality of notifications 30, with each notification 30 including reinforcement content 22. Each notification 30 generated by the content delivery program 26 is delivered to the trainee mobile device 18 based on the delivery preferences 28, which are calculated individually for each trainee mobile device 18. The delivery preferences 28 are indicative of when the trainee is most likely to receive the notification 30, and when the trainee is most likely to interact with the notification 30. A display 32 is situated on the trainee mobile device 18, and is used to show the notification 30 including the reinforcement content 22 after the notification 30 is received by the trainee mobile device 18.

The training reinforcement notification system 10 may optionally include a notification schedule. The notification schedule has multiple time slots, and it is generated by the content delivery program 26. The content delivery program 26 generates the notification schedule while running on the notification computer 14, and it uses the reinforcement content 22 received from the authoring platform computer 12, and the customization data 24 received from the trainee mobile device 18. The delivery preferences 28 for a particular notification 30 includes information such as a delivery time indicating when that notification 30 is going to be delivered, and the delivery time is generally assigned to one of the plurality of time slots.

Referring to FIG. 1, feedback information 34 is generated by the trainee mobile device 18 and transmitted to the notification computer 14 and the authoring platform computer 12. Feedback information 34 includes a variety of information, generated either before, during, or after the trainee mobile device 18 receives a particular notification 30. Feedback information 34 generally includes information such as whether and when the trainee mobile device 18 received the notification 30, and whether and to what extent the trainee actually interacted with the notification 30. Feedback information 34 may also include data relating to whether the trainee read or reviewed the words and information in the notification 30; whether the trainee answered any questions in the notification 30 and what the answers were; how long the trainee spent reviewing and interacting with the notification 30 both overall and for the various components; whether any portions of the notification 30 were skipped or ignored; and whether any part of the reinforcement content 22 or concepts contained in the notification 30 were partly or completely misunderstood. The feedback information 34 may also include device data for the trainee mobile device 18, which may be collected before, during, and after the notification 30 is sent and/or received and/or viewed, and may include information such as: the location of the trainee mobile device 18; whether the trainee mobile device 18 was being used and what it was being used for; and any other type of device data known by those of skill in the art and familiar with the present disclosure. The feedback information 34 may also include, but is not limited to, hand-scheduled tasks, calendar cues, work outcomes, trainer schedules, learning goals, learning history, and content selected and consumed by the learner independently.

The feedback information 34 can be used in order to modify both the timing and content of the notification 30. For example, if a first notification 30 is sent to the trainee mobile device 18 but it is not viewed, then a second notification 30 can be modified before being sent to the trainee mobile device 18 so that it contains reinforcement content 22 that can be understood by the trainee despite not having reviewed the first notification 30, e.g. the reinforcement content 22 of the second notification 30 can be modified to be the same as the reinforcement content 22 of the first notification 30. As another example, the reinforcement content 22 may be modified based on the feedback information 34 to include reinforcement content 22 that is more interesting or relevant to the trainee, or reinforcement content 22 of a certain type (e.g. quiz questions, charts, bullet points, etc.) that the trainee prefers. As another example, during the initial course the instructor notices a trainee is particularly interested in a certain topic, so the second notification 30 is modified to include reinforcement content 22 related to that topic if the first notification 30 is ignored. Additionally, the reinforcement content 22 and timing of a notification 30 can be modified based upon educational goals and competency requirements input by the trainer. As another example, when the trainee is entering customization data 24, they can state that they are bilingual, and then the second notification 30 can be sent in the trainee's other language if the first notification 30 is ignored. Any such information like language preferences, topics of interest, preferred styles of learning, etc., can be collected with the customization data 24 entered by the trainee, or entered by the instructor into the training program 20, or collected from third parties, e.g. via analysis of social media accounts, business applications, enterprise software systems, or company or user profile data. In embodiments, customization data 24 can include, but is not limited to, calendar events, work outcomes, trainer schedules, trainee schedules, learning goals, learning history, competency models, learning goals, and content selected and consumed by the learner independently.

The feedback information 34 can be used to change the delivery times of future notifications 30. This can be done in a number of ways. For example, a training program 20 is designed to be used to send daily notifications 30 to employees of a company on how to properly execute a company process that must be done before 12:00 PM. A first notification 30 is sent out to multiple trainees at 9:00 AM on Monday. The first notification 30 is ignored by a certain trainee, and the feedback information 34 from the trainee mobile device 18 indicates that the notification 30 was ignored and that the trainee mobile device 18 was moving at the time the notification 30 was delivered (e.g. because the trainee was still commuting to work). The content delivery program 26 modifies the delivery preferences 28 for that trainee mobile device 18 based on the feedback information 34 it received, and the delivery preferences 28 now indicate that notifications 30 should be sent at a later time for this particular trainee mobile device 18. The second notification 30 is then delivered at a later time on Tuesday morning (e.g. at 9:30 AM), since the delivery preferences 28 have been changed. However, in this case, the delivery preferences 28 wouldn't change the delivery time of the notification 30 to the afternoon, because the training program 20 has been designed to help employees properly execute a company process before 12:00 PM.

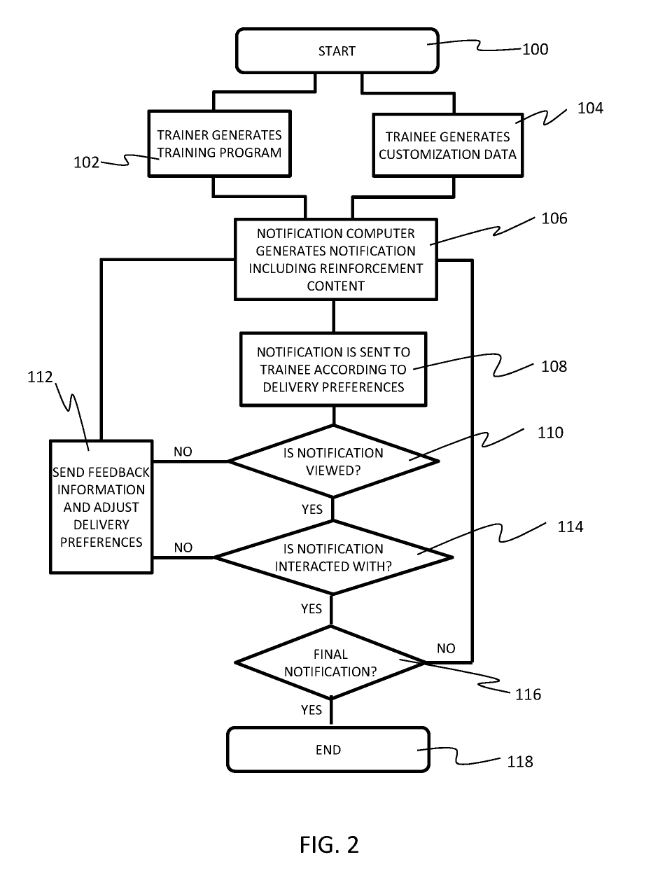

Referring to FIG. 2, a flowchart illustrating an exemplary process of operating the training reinforcement notification system 10 is shown. The method begins at the start 100. In a first step of the method, the trainer generates a training program 102, and a trainee generates customization data 104. This information is provided to the notification computer to generate notifications having reinforcement content 106. The notification is sent to a trainee device according to delivery preferences 108, which are derived from the information included in the training program and customization data previously sent to the notification computer in steps 102 and 104. The trainee device is checked to verify that the notification is viewed 110. If the notification is not viewed, then feedback information is sent to the notification computer, which adjusts the delivery preferences 112. If the notification is viewed, then the trainee device is checked to verify that the notification is interacted with 114. If the notification is not interacted with, then feedback information is sent to the notification computer, which adjusts the delivery preferences 112. If the notification is interacted with, then the notification computer checks whether it was the final notification 116. If it was not the final notification, then the process repeats from step 106. If it was the final notification, the method is complete 118.

The training reinforcement notification system 10 offers several advantages over known systems. Among other things, the training reinforcement notification system 10 includes reinforcement content 22 with each notification 30 so that the trainee can view the notification 30 and receive the information without having to click on any links or open up and attachments. This approach increases the likelihood that the trainee actually receives the information. The training reinforcement notification system 10 also provides an additional advantage over known systems by adapting the notifications 30 based on the feedback information 34. Known systems may include some amount of customization, but do not provide the individualized adaptability both in terms of when the notification 30 is delivered and what reinforcement content 22 is included with it. Thus, the training reinforcement notification system 10 provides an advantage over known systems by maximizing the likelihood that a trainee actually receives and reviews the notification 30 including the reinforcement content 22.

In embodiments, the training reinforcement notification system 10 can use machine learning, hand-coded prioritization, probability weighting, or any other decision-making process or algorithm to modify the delivery preferences 28, notifications 30, and reinforcement content 22.

In embodiments, the training reinforcement notification system 10 or any individual component of the training reinforcement notification system 10 can be an API.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A training reinforcement notification system, comprising:
an authoring platform computer for generating a training program including reinforcement content;
a notification computer that receives the reinforcement content and stores it in a notification database,
a trainee device that generates customization data which is received by the notification computer, where a content delivery program running on the notification computer processes the customization data and generates delivery preferences which are stored in the database;
the content delivery program retrieves the reinforcement content and delivery preferences from the database and generates a plurality of notifications each including reinforcement content;
each of the plurality of notifications generated by the content delivery program is delivered to the trainee device based on the delivery preferences, and the delivery preferences are unique to the trainee device;
a display situated on the trainee device shows each of the plurality of notifications including the reinforcement content after the notification is received by the trainee device.

2. The training reinforcement notification system of claim 1, wherein a notification schedule having a plurality of time slots is generated by the content delivery program based on the reinforcement content and the customization data.

3. The training reinforcement notification system of claim 2, wherein the delivery preferences of a particular notification includes a delivery time for when the particular notification is going to be delivered, and the delivery time is assigned to one of the plurality of time slots based on the customization data.

4. The training reinforcement notification system of claim 1, wherein feedback information is generated by the trainee device and transmitted to the notification computer.

5. The training reinforcement notification system of claim 4, wherein the feedback information is transmitted to the authoring platform computer.

6. The training reinforcement notification system of claim 5, wherein the feedback information indicates that the trainee received the notification.

7. The training reinforcement notification system of claim 6, wherein the feedback information indicates that the trainee interacted with the notification.

8. The training reinforcement notification system of claim 5, wherein the feedback information includes the device location and whether the device is being used.

9. The training reinforcement notification system of claim 4, wherein the plurality of notifications comprises a first notification and a second notification, and the second notification is generated after the first notification; and
the delivery preferences for the second notification are modified by the content delivery program based on the feedback information received by the notification computer after the trainee device received the first notification.

10. The training reinforcement notification system of claim 9, wherein the first notification has a plurality of first notification delivery preferences including a first notification delivery time;
the second notification has a plurality of second notification delivery preferences including a second notification delivery time; and
the second notification delivery time is set to the same time value as the first notification delivery time.

11. The training reinforcement notification system of claim 10, wherein the feedback information indicates the first notification was not received, and the content delivery program modifies the second notification delivery time to be different than the first notification delivery time.

12. The training reinforcement notification system of claim 10, wherein the feedback information indicates the first notification was not interacted with, and the content delivery program modifies the second notification delivery time to be different than the first notification delivery time.

13. The training reinforcement notification system of claim 10, wherein the feedback information indicates the first notification was not received, and the content delivery program modifies the reinforcement content of the second notification to be the same as the reinforcement content of the first notification.

14. The training reinforcement notification system of claim 4, wherein the plurality of notifications comprises a first notification, a second notification, and a third notification, such that the second notification is generated and sent to the trainee device after the first notification, and the third notification is generated and sent to the trainee device after the second notification; and
the reinforcement content of the third notification is modified by the content delivery program based on feedback information received by the notification computer after the trainee device received the first notification and feedback information received by the notification computer after the trainee device received the second notification.

15. The training reinforcement notification system of claim 14, wherein the reinforcement content of the first notification is of a first type and the reinforcement content of the second notification is of a second type;
the feedback information received by the notification computer after the trainee device received the first notification indicates that the first notification was not interacted with;
the feedback information received by the notification computer after the trainee device received the second notification indicates that the second notification was interacted with; and
the content delivery program generates the third notification to include reinforcement content of the second type.

16. The training reinforcement notification system of claim 1, wherein the delivery preferences are indicative of when the trainee is most likely to receive the notification, and when the trainee is most likely to interact with the notification.

17. The training reinforcement notification system of claim 1, wherein the trainee device is a mobile device.
